(19) United States
(12) Patent Application Publication
(10) Pub. No.: US 2026/0160706 A1
(43) Pub. Date: Jun. 11, 2026

(54) INSPECTION APPARATUS FOR SEMICONDUCTOR WAFER

(71) Applicant: PEMTRON Co., Ltd., Seoul (KR)

(72) Inventors: Cheol Hoon CHO, Goyang-si (KR); Jong Vin YIM, Seoul (KR); Hoon Jae CHOI, Incheon (KR)

(21) Appl. No.: 19/375,145

(22) Filed: Oct. 30, 2025

(30) Foreign Application Priority Data
Dec. 9, 2024 (KR) 10-2024-0181826

(51) Int. Cl. G01N 21/95; G01N 21/88; G01N 21/93

(52) U.S. Cl. CPC G01N 21/9501; G01N 21/8806; G01N 21/93; G01N 2021/8841; G01N 2201/021

(57) ABSTRACT

Proposed is an inspection apparatus for a semiconductor wafer. The inspection apparatus includes a wafer chuck on which the semiconductor wafer is seated, an imaging unit configured to image the semiconductor wafer seated on the wafer chuck, a main body having a horizontal body and a vertical body extending upward from the horizontal body, a horizontal movement module configured to support the imaging unit so that the imaging unit reciprocates in a transverse direction, with the imaging unit installed on the horizontal movement module, a wafer bracket coupled to an upper plate surface of the horizontal body to be rotatable by a predetermined angle about an axis in a vertical direction, and an imaging bracket coupled to a front plate surface of the vertical body to be rotatable by a predetermined angle about an axis in a longitudinal direction.

### CROSS REFERENCE TO RELATED APPLICATION

The present application claims priority to Korean Patent Application No. 10-2024-0181826, filed Dec. 9, 2024, the entire contents of which are incorporated herein for all purposes by this reference.

### BACKGROUND OF THE INVENTION

### Field of the Invention

The present disclosure relates generally to an inspection apparatus for a semiconductor wafer and more particularly, to an inspection apparatus for a semiconductor wafer, in which alignment adjustment for image capturing is performed.

### Description of the Related Art

In general, a semiconductor chip is produced by forming fine patterns on a silicon wafer, dicing the wafer into individual units, and then packaging them. By inspecting for defects on or within the wafer, such as dust adhering to the surface of the wafer or scratches formed thereon, or internal defects like air pockets, prior to the formation of the fine patterns, yield can be improved.

Such inspection of the surface and interior of a semiconductor wafer makes it possible to identify which process in the manufacturing line of the semiconductor wafer has a problem. Accordingly, not only can effective countermeasures be established for equipment manufacturing and processes, but yield improvement can also be achieved.

Meanwhile, conventionally, an operator visually examines defects on and within a semiconductor wafer by capturing images with conventional optical equipment, such as a camera, and enlarging images of portions suspected of having defects.

Due to the characteristics of optical equipment, the alignment between optical equipment, such as a camera, and a semiconductor wafer to be measured has a significant influence on the resolution, field of view (FOV), and the like of an image captured by a camera. Accordingly, alignment between the optical equipment and a wafer chuck on which the semiconductor wafer is seated serves as a critical factor prior to imaging.

For example, Korean Patent No. 10-0803758, entitled “INSPECTION DEVICE FOR SEMICONDUCTOR WAFER,” discloses a technology for improving inspection accuracy through alignment of a turntable on which a wafer is mounted.

However, in the case of the technology disclosed in the above Korean Patent, alignment is performed by driving the turntable itself, which results in a disadvantage of having a complicated structure.

In addition, generally, a turntable is fixedly installed on a main body of an inspection device, and in the case where the turntable is installed in an unaligned state during the installation process, there is a problem in that the unaligned state is continuously maintained.

Such a problem also arises in the installation structures of a camera or rail structures that move the camera in a horizontal direction, since if misalignment occurs during the installation process, it is difficult to correct.

### SUMMARY OF THE INVENTION

Accordingly, the present disclosure has been made keeping in mind the above problems occurring in the related art, and the present disclosure is intended to provide an inspection apparatus for a semiconductor wafer, in which alignment of various optical structures is adjustable for precise imaging.

In order to achieve the objectives of the present disclosure, there is provided an inspection apparatus for a semiconductor wafer, the inspection apparatus including: a wafer chuck on which the semiconductor wafer is seated; an imaging unit configured to image the semiconductor wafer seated on the wafer chuck; a main body having a horizontal body and a vertical body extending upward from the horizontal body; a horizontal movement module configured to support the imaging unit so that the imaging unit reciprocates in a transverse direction, with the imaging unit installed on the horizontal movement module; a wafer bracket coupled to an upper plate surface of the horizontal body to be rotatable by a predetermined angle about an axis in a vertical direction, with the wafer chuck installed on an upper plate surface of the wafer bracket; and an imaging bracket coupled to a front plate surface of the vertical body to be rotatable by a predetermined angle about an axis in a longitudinal direction, with the horizontal movement module installed on the imaging bracket, wherein alignment between the wafer chuck and the imaging unit is adjusted by adjusting a rotation angle of the wafer bracket with respect to the horizontal body and a rotation angle of the imaging bracket with respect to the vertical body.

Here, the inspection apparatus may further include: a wafer angle adjusting unit configured to adjust the rotation angle of the wafer bracket with respect to the horizontal body; and an imaging angle adjusting unit configured to adjust the rotation angle of the imaging bracket with respect to the vertical body.

In addition, the wafer angle adjusting unit may include one pair of wafer angle adjusting blocks which are installed on the horizontal body to be spaced apart from each other in the longitudinal direction, and move respective opposite sides of the wafer bracket in the longitudinal direction in opposite directions along the transverse direction so as to adjust the rotation angle of the wafer bracket about the axis in the vertical direction.

Additionally, the imaging angle adjusting unit may include one pair of imaging angle adjusting blocks, which are installed on the vertical body to be spaced apart from each other the transverse direction and move respective opposite sides of the imaging bracket in the transverse direction in opposite directions along the vertical direction so as to adjust the rotation angle of the imaging bracket about the axis in the longitudinal direction.

In addition, the horizontal movement module may include: an imaging mounting module on which the imaging unit is mounted; and a guide rail installed on a front plate surface of the imaging bracket along the transverse direction and configured to guide reciprocating movement of the imaging mounting module in the transverse direction.

In an embodiment, the imaging mounting module may support the imaging unit so that a rotation angle thereof is adjusted about axes in at least two directions among the transverse direction, the longitudinal direction, and the vertical direction.

Here, the imaging mounting module may include: a front bracket having a front surface on which the imaging unit is installed; a first middle bracket coupled to a rear side of the front bracket and configured to support the front bracket to be rotatable about an axis in one direction among the transverse direction, the longitudinal direction, and the vertical direction; a second middle bracket coupled to a rear side of the first middle bracket and configured to support the first middle bracket to be rotatable about an axis in another direction among the transverse direction, the longitudinal direction, and the vertical direction; and a rear bracket coupled to a rear side of the second middle bracket and configured to support the second middle bracket to be rotatable about an axis in one remaining direction among the transverse direction, the longitudinal direction, and the vertical direction.

In an embodiment, the inspection apparatus may further include: one pair of rotation shaft support blocks installed respectively on opposite sides of a rear bracket in the transverse direction; and rotation shaft members which are installed at positions on opposite sides of a second middle bracket in the transverse direction, with the positions corresponding to the respective rotation shaft support blocks, and are coupled to the rotation shaft support blocks so as to be rotatable about an axis in the transverse direction.

Here, the inspection apparatus may further include: at least one first angle fixing plate having a first side fixed to a side surface in the transverse direction of one of the rear bracket and the second middle bracket and having a second side extending toward a remaining one of the rear bracket and the second middle bracket, wherein the first angle fixing plate has at least one first angle fixing through-hole formed by penetrating a plate surface thereof in the transverse direction and extending in the longitudinal direction, and while a rotation angle of the second middle bracket about the axis in the transverse direction with respect to the rear bracket is adjusted, a fixing bolt passing through the first angle fixing through-hole is fastened to a side surface in the transverse direction of the remaining one of the rear bracket and the second middle bracket to fix the angle.

In an embodiment, a first rotational shaft portion may be formed in a central region of a rear plate surface of a first middle bracket, and a second rotational shaft portion, which is axially coupled to the first rotational shaft portion, may be formed in a central region of a front plate surface of a second middle bracket, so that the first middle bracket rotates about the axis in the longitudinal direction with respect to the second middle bracket.

Here, a second angle fixing through-hole having an arc shape corresponding to the rotation of the first middle bracket may be formed by penetrating at least one of four corners of one of the first middle bracket and the second middle bracket in the longitudinal direction, and while a rotation angle of the first middle bracket about the axis in the longitudinal direction with respect to the second middle bracket is adjusted, a fixing bolt passing through the second angle fixing through-hole may be fastened to a plate surface of a remaining one of the first middle bracket and the second middle bracket to fix the angle.

In an embodiment, one of a front bracket and a first middle bracket may have one pair of shaft protrusions formed to protrude from opposite sides thereof in the vertical direction to face each other in the vertical direction, and a remaining one of the front bracket and the first middle bracket may have shaft holes formed respectively on opposite sides thereof in the vertical direction so that the one pair of shaft protrusions are respectively inserted into and coupled to the shaft holes, being rotatable about the axis in the vertical direction.

Here, the inspection apparatus may further include: at least one third angle fixing plate having a first side fixed to an end plate surface of one of the front bracket and the first middle bracket in the vertical direction and having a second side extending toward a remaining one of the front bracket and the first middle bracket, wherein the third angle fixing plate may have at least one second angle fixing through-hole formed by penetrating a plate surface thereof in the vertical direction and extending in the longitudinal direction, and while a rotation angle of the front bracket about the axis of the vertical direction with respect to the first middle bracket is adjusted, a fixing bolt passing through a third angle fixing through-hole may be fastened to an end plate surface in the vertical direction of the remaining one of the front bracket and the first middle bracket to fix the angle.

According to the above configuration, the present disclosure provides an inspection apparatus for a semiconductor wafer, in which alignment of various optical structures is adjustable for precise imaging.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of an inspection apparatus for a semiconductor wafer according to the embodiment of the present disclosure;

FIG. 2 is a front view of the inspection apparatus for a semiconductor wafer according to an embodiment of the present disclosure;

FIGS. 3 to 5 are perspective views of the inspection apparatus for a semiconductor wafer according to an embodiment of the present disclosure, with an imaging unit removed;

FIG. 6 is a side view of the inspection apparatus for a semiconductor wafer according to an embodiment of the present disclosure, with the imaging unit removed;

FIG. 7 is a perspective view of an imaging mounting module of the inspection apparatus for a semiconductor wafer according to an embodiment of the present disclosure;

FIG. 8 is a side view of the imaging mounting module of the inspection apparatus for a semiconductor wafer according to an embodiment of the present disclosure;

FIG. 9 is a top view of the imaging mounting module of the inspection apparatus for a semiconductor wafer according to an embodiment of the present disclosure; and

FIG. 10 is a front perspective view of the imaging mounting module of the inspection apparatus for a semiconductor wafer according to an embodiment of the present disclosure;

FIG. 11 is a rear perspective view of the imaging mounting module of the inspection apparatus for a semiconductor wafer according to an embodiment of the present disclosure.

### DETAILED DESCRIPTION OF THE INVENTION

Advantages and features of the present disclosure, as well as methods for achieving them, will become apparent with reference to embodiments described in detail below in conjunction with the accompanying drawings. However, the present disclosure is not limited to the embodiments disclosed below but may be implemented in various other forms. The embodiments are provided merely to make the disclosure of the present disclosure complete and to fully inform those skilled in the art to which the present disclosure pertains of the scope of the present disclosure, and the present disclosure is defined only by the scope of the claims.

The terms used in the present specification are intended to describe the embodiments and are not intended to limit the present disclosure. As used in the present specification, singular forms also include plural forms unless otherwise specified in the context. The terms “comprises” and/or “comprising” used in this specification do not exclude the presence or addition of one or more other components in addition to the stated components. Throughout the specification, the same reference numerals refer to the same components, and “and/or” includes each of the stated components as well as any combination of one or more of them. Although terms such as “first” and “second” are used to describe various components, these components are not limited by these terms. These terms are used merely to distinguish one component from another component. Therefore, a first component mentioned below may be a second component within the technical spirit of the present disclosure.

Unless otherwise defined, all terms (including technical and scientific terms) used in this specification are to be construed as having meanings commonly understood by those skilled in the art to which the present disclosure pertains. In addition, terms that are defined in commonly used dictionaries are not to be interpreted in an idealized or overly formal sense unless explicitly defined otherwise.

Hereinafter, embodiments according to the present disclosure will be described in detail with reference to the accompanying drawings.

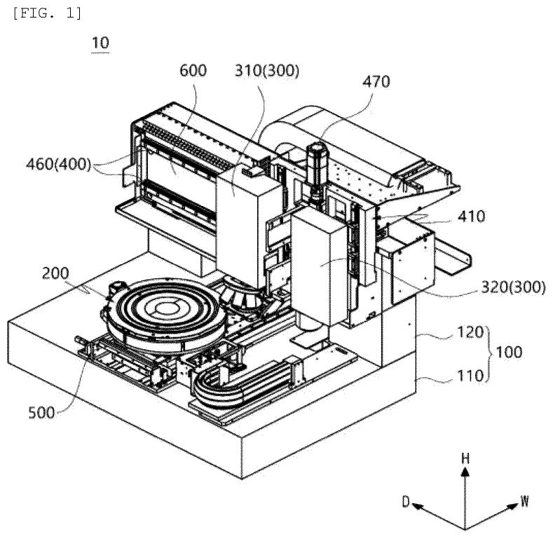

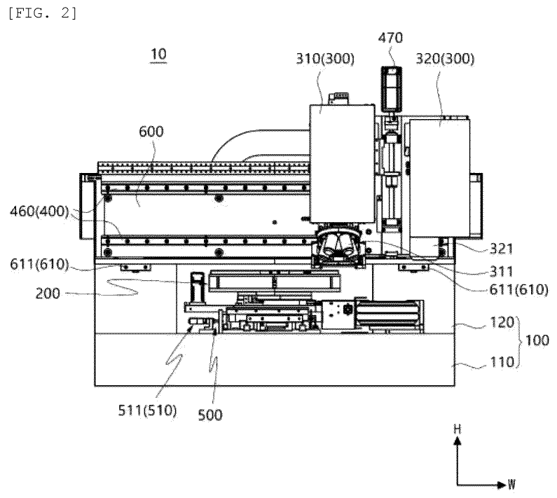

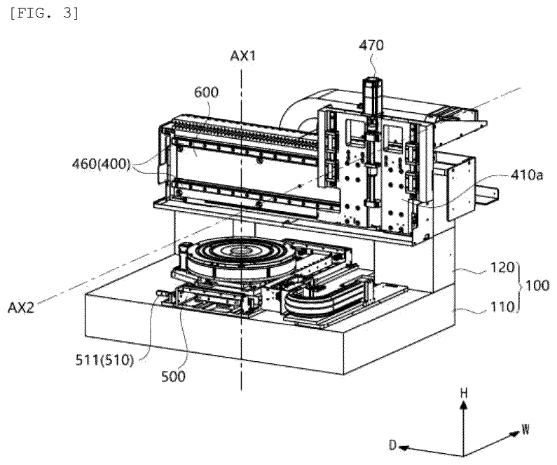

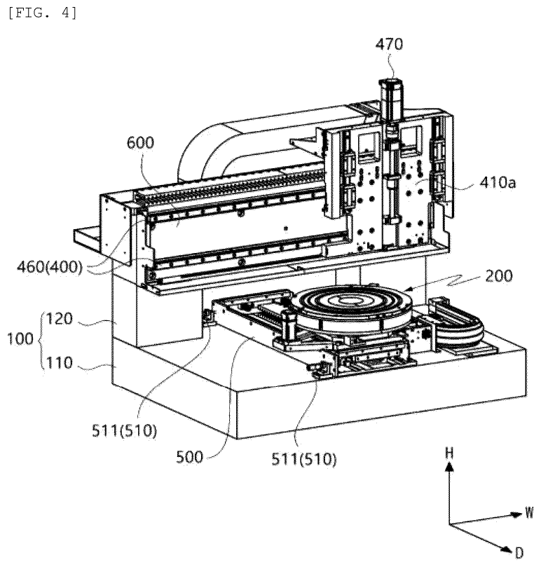

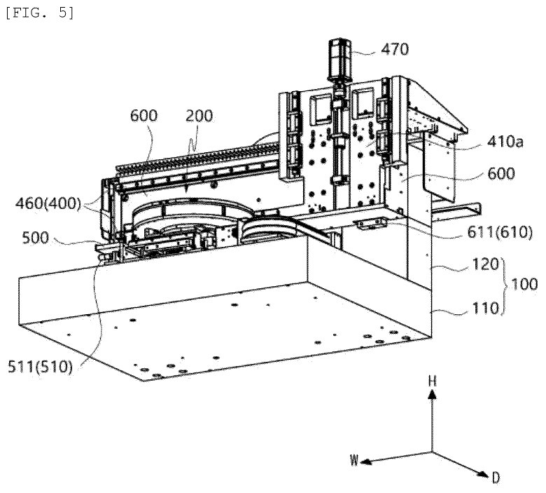

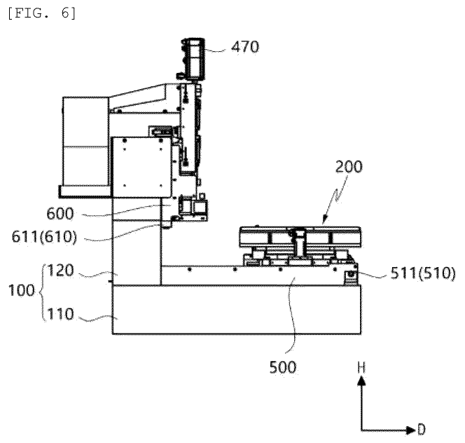

FIG. 1 is a perspective view of an inspection apparatus for a semiconductor wafer according to the embodiment of the present disclosure, FIG. 2 is a front view of the inspection apparatus for a semiconductor wafer according to an embodiment of the present disclosure, FIGS. 3 to 5 are perspective views of the inspection apparatus for a semiconductor wafer according to an embodiment of the present disclosure, with an imaging unit removed, and FIG. 6 is a side view of the inspection apparatus for a semiconductor wafer according to an embodiment of the present disclosure, with the imaging unit removed.

Referring to FIGS. 1 to 6, an inspection apparatus 10 for a semiconductor wafer according to the embodiment of the present disclosure may include a wafer chuck 200, an imaging unit 300, a main body 100, a horizontal movement module 400, a wafer bracket 500, and an imaging bracket 600.

A semiconductor wafer may be seated on the wafer chuck 200 according to the embodiment of the present disclosure. In an embodiment, the wafer chuck 200 may be provided to be movable in at least one direction of a transverse direction W and a longitudinal direction D. For example, the wafer chuck 200 may be provided to be movable in the longitudinal direction D.

The imaging unit 300 according to an embodiment of the present disclosure images the semiconductor wafer seated on the wafer chuck 200. In an embodiment, the imaging unit 300 may include a 2D camera module 310 for capturing a 2D image of the semiconductor wafer, and a 3D camera module 320 for capturing a 3D image of the semiconductor wafer.

Here, the 2D camera module 310 and the 3D camera module 320 may be installed on the wafer bracket 500 so as to be movable in a vertical direction H. In an embodiment, the horizontal movement module 400 may be provided with a vertical driving unit 470 for moving the imaging unit 300 in the vertical direction.

The main body 100 according to an embodiment of the present disclosure may include a horizontal body 110 and a vertical body 120.

The horizontal body 110 constitutes the entire frame of a portion of the main body 100, which is seated on the floor. In an embodiment, the horizontal body 110 is exemplified as having a substantially rectangular parallelepiped shape.

The vertical body 120 extends upward from the horizontal body 110. In the present disclosure, the vertical body 120 extends upward from the upper plate surface of the horizontal body 110, specifically, from the rear edge of the upper plate surface in the longitudinal direction D.

The imaging unit 300 is installed on the horizontal movement module 400 according to an embodiment of the present disclosure. In addition, the horizontal movement module 400 supports the imaging unit 300 so that the imaging unit 300 reciprocates in the transverse direction W, with the imaging unit 300 installed on the horizontal movement module 400.

As described above, in an embodiment of the present disclosure, the imaging unit is composed of the 2D camera module 310 and the 3D camera module 320. When capturing a 2D image by using the 2D camera module 310, the horizontal movement module 400 moves in the transverse direction W so that the 2D camera module 310 is positioned above the wafer chuck 200. In addition, when capturing a 3D image by using the 3D camera module 320, the horizontal movement module 400 moves in the transverse direction W so that the 3D camera module 320 is positioned above the wafer chuck 200.

For another example, when the 2D camera module 310 or the 3D camera module 320 is positioned above the wafer chuck 200, the 2D camera module 310 or the 3D camera module 320 is located close to the semiconductor wafer seated on the wafer chuck 200. Accordingly, when the 2D camera module 310 or the 3D camera module 320 is positioned above the wafer chuck 200, it is difficult to seat the semiconductor wafer on the wafer chuck 200 or to remove the semiconductor wafer from the wafer chuck 200.

In this case, during the transfer of the semiconductor wafer, the imaging unit 300 may be moved in the transverse direction W so that the 2D camera module 310 and the 3D camera module 320 are not positioned above the wafer chuck 200 as shown in FIG. 1.

The wafer chuck 200 is installed on the upper plate surface of the wafer bracket 500 according to an embodiment of the present disclosure. In addition, the wafer bracket 500 is coupled to the upper plate surface of the horizontal body 110 so as to be rotatable by a predetermined angle about an axis Ax1 in the vertical direction H.

Through such a configuration, instead of directly fixing the wafer chuck 200 to the horizontal body 110, the wafer chuck 200 is fixed to the wafer bracket 500, and the wafer bracket 500 is coupled to the horizontal body 110 so as to be rotatable by a predetermined angle about the axis Ax1 in the vertical direction H with respect to the horizontal body 110, and thus the alignment of the wafer chuck 200 may be adjusted about the axis Ax1 in the vertical direction H.

Meanwhile, the horizontal movement module 400 may be installed on the imaging bracket 600. In addition, the imaging bracket 600 may be coupled to the front plate surface of the vertical body 120 so as to be rotatable by a predetermined angle about an axis Ax2 in the longitudinal direction D.

Through such a configuration, instead of directly fixing the horizontal movement module 400 to the vertical body 120, the horizontal movement module 400 is fixed to the imaging bracket 600, and the imaging bracket 600 is coupled to the vertical body 120 so as to be rotatable by a predetermined angle about the axis Ax2 in the longitudinal direction D with respect to the vertical body 120, thereby adjusting the alignment of the imaging unit 300 about the axis Ax2 in the longitudinal direction D.

Through the above configuration, alignment between the wafer chuck 200 and the imaging unit 300 may be adjusted by adjusting the angle of the wafer chuck 200 by using the wafer bracket 500 and by adjusting the angle of the imaging unit 300 by using the imaging bracket 600.

In an embodiment, the inspection apparatus 10 for a semiconductor wafer may include a wafer angle adjusting unit 510 and an imaging angle adjusting unit 610.

The wafer angle adjusting unit 510 according to an embodiment of the present disclosure may adjust the rotation angle of the wafer bracket 500 relative to the horizontal body, that is, the rotation angle of the wafer bracket 500 about the axis Ax1 in the vertical direction H.

In an embodiment, the wafer angle adjusting unit 510 may include one pair of wafer angle adjusting blocks 511 installed on the horizontal body 110 to be spaced apart from each other in the longitudinal direction D. The pair of wafer angle adjusting blocks 511 may move respective opposite sides of the wafer bracket 500 in the longitudinal direction D in opposite directions along the transverse direction W, thereby adjusting the rotation angle of the wafer bracket 500 about the axis Ax1 in the vertical direction H.

In the present disclosure, as an example, each of the wafer angle adjusting blocks 511 adjusts the angle of the wafer bracket 500 by moving the respective opposite sides of the wafer bracket 500 in the longitudinal direction D in opposite directions along the transverse direction W through forward and reverse rotations of an adjustment bolt (not shown).

The imaging angle adjusting unit 610 according to an embodiment of the present disclosure may adjust the rotation angle of the imaging bracket 600 with respect to the vertical body 120.

In an embodiment, the imaging angle adjusting unit 610 may include one pair of imaging angle adjusting blocks 611 installed on the vertical body 120 to be spaced apart from each other in the transverse direction W.

The pair of imaging angle adjusting blocks 611 may move the respective opposite sides of the imaging bracket 600 in the transverse direction W in opposite directions along the vertical direction H, thereby adjusting the rotation angle of the imaging bracket 600 about the axis Ax2 in the longitudinal direction D.

In the present disclosure, as an example, each of the imaging angle adjusting blocks 611 adjusts the angle of the imaging bracket 600 by moving the respective opposite sides of the imaging bracket 600 in the transverse direction W in opposite directions along the vertical direction H through forward and reverse rotations of an adjustment bolt (not shown).

Meanwhile, the horizontal movement module according to an embodiment of the present disclosure may include the imaging mounting module 410 and a guide rail 460.

The imaging unit 300 may be mounted on the imaging mounting module 410 according to an embodiment of the present disclosure. As described above, the imaging unit 300 includes the 2D camera module 310 and the 3D camera module 320, wherein the 2D camera module 310 and the 3D camera module 320 are arranged in the transverse direction W on the imaging mounting module 410.

The guide rail 460 according to an embodiment of the present disclosure may be installed on the front plate surface of the imaging bracket 600 along the transverse direction W. Here, the guide rail 460 guides the reciprocating movement of the imaging mounting module 410 in the transverse direction W.

In an embodiment, in FIGS. 3 to 5, the imaging mounting module 410 is exemplified as being configured in the form of a mounting plate 410a, and the imaging unit 300 is exemplified as being mounted on the plate.

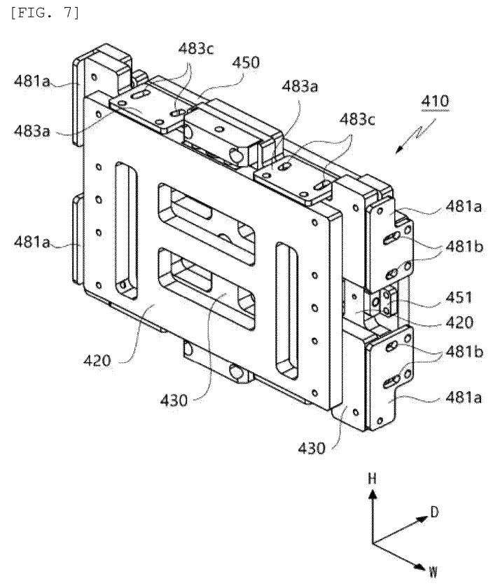

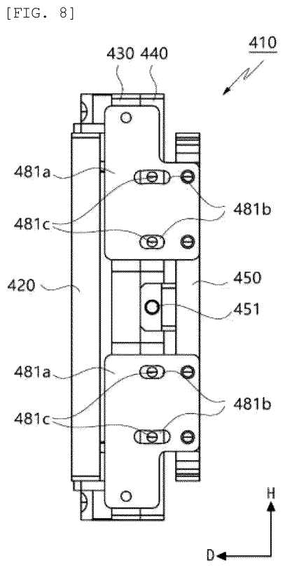

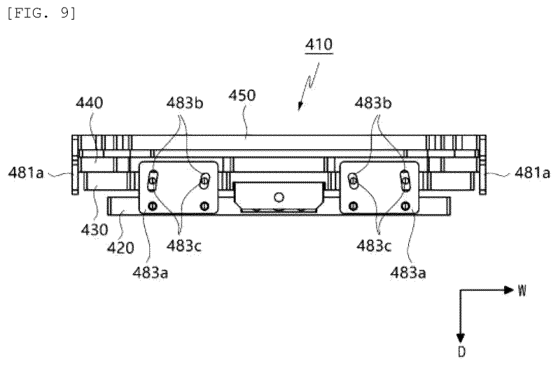

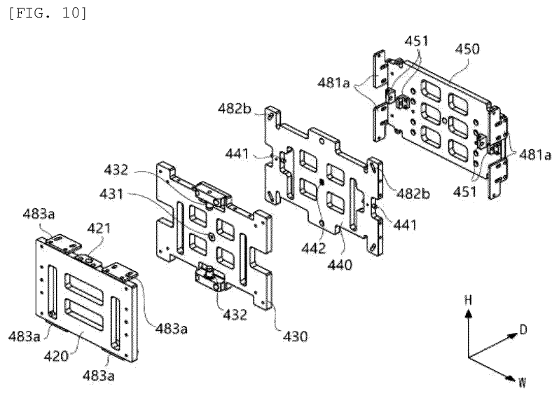

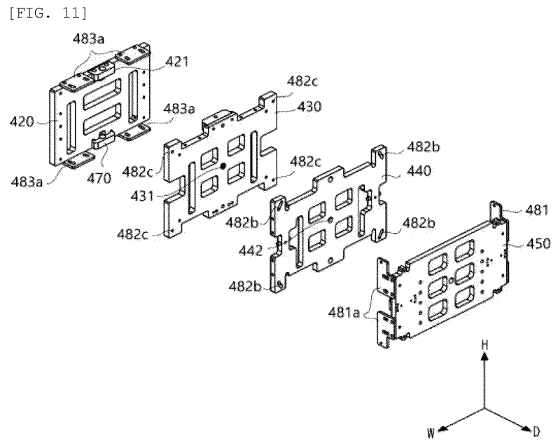

FIGS. 7 to 11 are views illustrating the imaging mounting module 410 according to another embodiment of the present disclosure.

The imaging mounting module 410 shown in FIGS. 7 to 11 supports the imaging unit 300 to be rotatable about each of axes in the transverse direction W, the longitudinal direction D, and the vertical direction H. In an embodiment, the imaging mounting module 410 may support the imaging unit 300 to be rotatable with the imaging mounting module 410 fixed to the mounting plate 410a shown in FIGS. 3 to 5. In another example, a rear bracket 450 of the imaging mounting module 410, which will be described later, may constitute the rear surface of the imaging mounting module 410.

Referring to FIGS. 7 to 11, the imaging mounting module 410 according to an embodiment of the present disclosure may include a front bracket 420, a first middle bracket 430, a second middle bracket 440, and the rear bracket 450. In an embodiment, the front bracket 420, the first middle bracket 430, the second middle bracket 440, and the rear bracket 450 are sequentially arranged from the front in the longitudinal direction D.

The imaging unit 300 is installed on the front surface of the front bracket 420. As described above, the 2D camera module 310 and the 3D camera module 320 may be installed on the front bracket 420 in the state in which the 2D camera module 310 and the 3D camera module 320 is arranged in the transverse direction W.

The first middle bracket 430 may be coupled to the rear side of the front bracket 420. In addition, the first middle bracket 430 supports the front bracket 420 to be rotatable about any one of the axes in the transverse direction W, the longitudinal direction D, or the vertical direction H.

In an embodiment of the present disclosure, the first middle bracket 430 is exemplified as supporting the front bracket 420 to be rotatable about the axis in the vertical direction H.

In one embodiment, one of the front bracket 420 and the first middle bracket 430 may have one pair of shaft protrusions 432 formed to protrude from opposite sides thereof in the vertical direction H to face each other in the vertical direction H. In an embodiment of the present disclosure, the pair of shaft protrusions 432 is exemplified as protruding to face each other on the opposite edges of the first middle bracket 430 in the vertical direction H.

In addition, the remaining one of the front bracket 420 and the first middle bracket 430 may have shaft holes 421 formed respectively on the opposite sides thereof in the vertical direction H so that the one pair of shaft protrusions 432 are respectively inserted into and coupled to the shaft holes 421, being rotatable about the axis in the vertical direction H. In an embodiment of the present disclosure, corresponding to the formation of the pair of shaft protrusions 432 on the first middle bracket 430, the shaft holes 421, into which the shaft protrusions 432 are respectively inserted, are exemplified as being formed on the opposite edges of the front bracket 420 in the vertical direction H.

The second middle bracket 440 according to an embodiment of the present disclosure is coupled to the rear side of the first middle bracket 430. In addition, the second middle bracket 440 supports the first middle bracket 430 to be rotatable about an axis of another direction among the transverse direction W, the longitudinal direction D, and the vertical direction H.

In an embodiment of the present disclosure, the second middle bracket 440 is exemplified as supporting the first middle bracket 430 to be rotatable about the axis in the longitudinal direction D.

In an embodiment, a first rotational shaft portion 431 may be formed in the central region of the rear plate surface of the first middle bracket 430. In addition, a second rotational shaft portion 442, which is axially coupled to the first rotational shaft portion 431, may be formed in the central region of the front plate surface of the second middle bracket 440.

Through this, the first middle bracket 430 is rotatable about the axis in the longitudinal direction D with respect to the second middle bracket 440.

The rear bracket 450 according to an embodiment of the present disclosure is coupled to the rear side of the second middle bracket 440. In addition, the rear bracket 450 supports the second middle bracket 440 to be rotatable about an axis in one remaining direction among the transverse direction W, the longitudinal direction D, and the vertical direction H.

In an embodiment of the present disclosure, the rear bracket 450 is exemplified as supporting the second middle bracket 440 to be rotatable about the axis in the transverse direction W.

In an embodiment, one pair of rotation shaft support blocks 451 may be respectively installed on opposite sides of the rear bracket 450 in the transverse direction W. In addition, rotation shaft members 441 may be respectively installed at positions on opposite sides of the second middle bracket 440 in the transverse direction W, with the positions corresponding to the respective rotation shaft support blocks 451. Here, the rotation shaft members 441 may be coupled to the pair of rotation shaft support blocks 451 so as to be rotatable about the axis in the transverse direction W.

In an embodiment, the rotation shaft support blocks 451 may have through-holes formed therethrough in the transverse direction W, and the rotation shaft members 441 having cylindrical shapes may be inserted into the through-holes to be rotatably coupled thereto.

Meanwhile, the imaging mounting module 410 according to the embodiment of the present disclosure may include at least one first angle fixing plate 481a.

A first side of the first angle fixing plate 481a may be fixed to a side surface in the transverse direction W of one of the rear bracket 450 and the second middle bracket 440. In addition, a second side of the first angle fixing plate 481a may extend toward the other of the rear bracket 450 and the second middle bracket 440.

In an embodiment of the present disclosure, the first angle fixing plate 481a is exemplified as extending toward the second middle bracket 440, that is, toward the front side, while the first angle fixing plate 481a is fixed to the side surface of the rear bracket 450. In addition, on each of the opposite sides of the rear bracket 450 in the transverse direction W, two first angle fixing plates 481a, that is, a total of four first angle fixing plates 481a are installed in the vertical direction H.

Here, each of the first angle fixing plates 481a may have at least one first angle fixing through-hole 481b formed by penetrating the plate surface thereof in the transverse direction W. In an embodiment of the present disclosure, two first angle fixing through-holes 481b are exemplified as being formed.

According to the above configuration, while the rotation angle of the second middle bracket 440 about the axis in the transverse direction W with respect to the rear bracket 450 is adjusted, a fixing bolt (not shown) passing through the first angle fixing through-hole 481b may be fastened to the side surface of the second middle bracket 440 in the transverse direction W to fix the angle.

Here, a first angle fixing fastening hole 481c for fastening the fixing bolt may be formed on the side surface of the second middle bracket 440 in the transverse direction W.

Meanwhile, in an embodiment of the present disclosure, a second angle fixing through-hole 482b may be formed in at least one of four corners of one of the first middle bracket 430 and the second middle bracket 440.

In an embodiment, the second angle fixing through-hole 482b may be formed at each of the four corners of the second middle bracket 440. Here, the second angle fixing through-hole 482b may be formed to have an arc shape corresponding to the rotation of the first middle bracket 430.

In an embodiment, while the rotation angle of the first middle bracket 430 about the axis in the longitudinal direction D with respect to the second middle bracket 440 is adjusted, a fixing bolt (not shown) passing through the second angle fixing through-hole 482b may be fastened to the plate surface of the first middle bracket 430 to fix the angle.

Here, a second angle fixing fastening hole 482c for fastening the fixing bolt passing through the second angle fixing through-hole 482b may be formed on the rear plate surface of the first middle bracket 430.

Meanwhile, according to an embodiment of the present disclosure, the imaging mounting module 410 may include at least one third angle fixing plate 483a.

According to an embodiment of the present disclosure, a first side of the third angle fixing plate 483a may be fixed to an end surface of one of the front bracket 420 and the first middle bracket 430 in the vertical direction H. In addition, a second side of the third angle fixing plate 483a may extend toward the other of the front bracket 420 and the first middle bracket 430.

In an embodiment of the present disclosure, the third angle fixing plate 483a is fixed to the end surface of the front bracket 420 in the vertical direction H and extends toward the first middle bracket 430, that is, toward the rear side. In addition, as an example, two third angle fixing plates 483a are installed in the transverse direction W on each of the opposite sides of the front bracket 420 in the vertical direction H, that is, a total of four third angle fixing plates 483a are installed.

Here, each of the third angle fixing plates 483a may have at least one third angle fixing through-hole 483b formed by penetrating a plate surface thereof in the vertical direction H. In an embodiment of the present disclosure, two third angle fixing through-holes 483b are formed.

According to the above configuration, while the rotation angle of the front bracket 420 about the axis of the vertical direction H with respect to the first middle bracket 430 is adjusted, a fixing bolt (not shown) passing through the third angle fixing through-hole 483b may be fastened to the end surface of the first middle bracket 430 in the vertical direction H to fix the angle.

Here, a third angle fixing fastening hole 483c for fastening the fixing bolt may be formed on the end surface of the first middle bracket 430 in the vertical direction H.

Meanwhile, the reference numeral 470, which is not described in FIGS. 1 to 6, denotes the vertical driving unit configured to move the imaging unit 300 in the vertical direction H.

Although some embodiments of the present disclosure have been illustrated and described, those skilled in the art to which the present disclosure pertains will recognize that the embodiments may be modified without departing from the principles and spirit of the present disclosure. The scope of the present disclosure is defined by the appended claims and their equivalents.

What is claimed is:

1. An inspection apparatus for a semiconductor wafer, the inspection apparatus comprising:
a wafer chuck on which the semiconductor wafer is seated;
an imaging unit configured to image the semiconductor wafer seated on the wafer chuck;
a main body having a horizontal body and a vertical body extending upward from the horizontal body;
a horizontal movement module configured to support the imaging unit so that the imaging unit reciprocates in a transverse direction, with the imaging unit installed on the horizontal movement module;
a wafer bracket coupled to an upper plate surface of the horizontal body to be rotatable by a predetermined angle about an axis in a vertical direction, with the wafer chuck installed on an upper plate surface of the wafer bracket; and
an imaging bracket coupled to a front plate surface of the vertical body to be rotatable by a predetermined angle about an axis in a longitudinal direction, with the horizontal movement module installed on the imaging bracket,
wherein alignment between the wafer chuck and the imaging unit is adjusted by adjusting a rotation angle of the wafer bracket with respect to the horizontal body and a rotation angle of the imaging bracket with respect to the vertical body.

2. The inspection apparatus of claim 1, further comprising:
a wafer angle adjusting unit configured to adjust the rotation angle of the wafer bracket with respect to the horizontal body; and
an imaging angle adjusting unit configured to adjust the rotation angle of the imaging bracket with respect to the vertical body.

3. The inspection apparatus of claim 2, wherein the wafer angle adjusting unit comprises one pair of wafer angle adjusting blocks which are installed on the horizontal body to be spaced apart from each other in the longitudinal direction, and move respective opposite sides of the wafer bracket in the longitudinal direction in opposite directions along the transverse direction so as to adjust the rotation angle of the wafer bracket about the axis in the vertical direction.

4. The inspection apparatus of claim 2, wherein the imaging angle adjusting unit comprises one pair of imaging angle adjusting blocks, which are installed on the vertical body to be spaced apart from each other the transverse direction and move respective opposite sides of the imaging bracket in the transverse direction in opposite directions along the vertical direction so as to adjust the rotation angle of the imaging bracket about the axis in the longitudinal direction.

5. The inspection apparatus of claim 1, wherein the horizontal movement module comprises:
an imaging mounting module on which the imaging unit is mounted; and
a guide rail installed on a front plate surface of the imaging bracket along the transverse direction and configured to guide reciprocating movement of the imaging mounting module in the transverse direction.

6. The inspection apparatus of claim 5, wherein the imaging mounting module supports the imaging unit so that a rotation angle thereof is adjusted about axes in at least two directions among the transverse direction, the longitudinal direction, and the vertical direction.

7. The inspection apparatus of claim 6, wherein the imaging mounting module comprises:
a front bracket having a front surface on which the imaging unit is installed;
a first middle bracket coupled to a rear side of the front bracket and configured to support the front bracket to be rotatable about an axis in one direction among the transverse direction, the longitudinal direction, and the vertical direction;
a second middle bracket coupled to a rear side of the first middle bracket and configured to support the first middle bracket to be rotatable about an axis in another direction among the transverse direction, the longitudinal direction, and the vertical direction; and
a rear bracket coupled to a rear side of the second middle bracket and configured to support the second middle bracket to be rotatable about an axis in one remaining direction among the transverse direction, the longitudinal direction, and the vertical direction.

8. The inspection apparatus of claim 7, further comprising:
one pair of rotation shaft support blocks installed respectively on opposite sides of the rear bracket in the transverse direction; and
rotation shaft members which are installed at positions on opposite sides of the second middle bracket in the transverse direction, with the positions corresponding to the respective rotation shaft support blocks, and are coupled to the rotation shaft support blocks so as to be rotatable about an axis in the transverse direction.

9. The inspection apparatus of claim 8, further comprising:
at least one first angle fixing plate having a first side fixed to a side surface in the transverse direction of one of the rear bracket and the second middle bracket and having a second side extending toward a remaining one of the rear bracket and the second middle bracket,
wherein the first angle fixing plate has at least one first angle fixing through-hole formed by penetrating a plate surface thereof in the transverse direction and extending in the longitudinal direction, and
while a rotation angle of the second middle bracket about the axis in the transverse direction with respect to the rear bracket is adjusted, a fixing bolt passing through the first angle fixing through-hole is fastened to a side surface in the transverse direction of the remaining one of the rear bracket and the second middle bracket to fix the angle.

10. The inspection apparatus of claim 6, wherein a first rotational shaft portion is formed in a central region of a rear plate surface of a first middle bracket, and
a second rotational shaft portion, which is axially coupled to the first rotational shaft portion, is formed in a central region of a front plate surface of a second middle bracket, so that the first middle bracket rotates about the axis in the longitudinal direction with respect to the second middle bracket.

11. The inspection apparatus of claim 10, wherein a second angle fixing through-hole having an arc shape corresponding to the rotation of the first middle bracket is formed by penetrating at least one of four corners of one of the first middle bracket and the second middle bracket in the longitudinal direction, and
while a rotation angle of the first middle bracket about the axis in the longitudinal direction with respect to the second middle bracket is adjusted, a fixing bolt passing through the second angle fixing through-hole is fastened to a plate surface of a remaining one of the first middle bracket and the second middle bracket to fix the angle.

12. The inspection apparatus of claim 7, wherein one of the front bracket and the first middle bracket has one pair of shaft protrusions formed to protrude from opposite sides thereof in the vertical direction to face each other in the vertical direction, and
a remaining one of the front bracket and the first middle bracket has shaft holes formed respectively on opposite sides thereof in the vertical direction so that the one pair of shaft protrusions are respectively inserted into and coupled to the shaft holes, being rotatable about the axis in the vertical direction.

13. The inspection apparatus of claim 12, further comprising:
at least one third angle fixing plate having a first side fixed to an end plate surface of one of the front bracket and the first middle bracket in the vertical direction and having a second side extending toward a remaining one of the front bracket and the first middle bracket,
wherein the third angle fixing plate has at least one second angle fixing through-hole formed by penetrating a plate surface thereof in the vertical direction and extending in the longitudinal direction, and
while a rotation angle of the front bracket about the axis of the vertical direction with respect to the first middle bracket is adjusted, a fixing bolt passing through the third angle fixing through-hole is fastened to an end plate surface in the vertical direction of the remaining one of the front bracket and the first middle bracket to fix the angle.
